(19) United States
(12) Patent Application Publication
(10) Pub. No.: US 2008/0316041 A1
(43) Pub. Date: Dec. 25, 2008

(54) PORTABLE ELECTRONIC DEVICE AND OPERATING METHOD FOR THE SAME

(75) Inventor: SHEN-FU TSAI, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/926,678

(22) Filed: Oct. 29, 2007

(30) Foreign Application Priority Data
Jun. 22, 2007 (CN) 200710200862.9

(51) Int. Cl. G08B 21/00

(52) U.S. Cl. 340/670

(57) ABSTRACT

A portable electronic device includes a movement sensor and a processor. The movement sensor is configured for detecting different types of movements of the portable electronic device and generating a corresponding signal representing each type of movement. The processor is configured for receiving the signal generated by the movement sensor and generating an operating signal for operating the portable electronic device corresponding to each movement type.

### TECHNICAL FIELD

The present invention relates to a portable electronic device and operating method for the same and, particularly, to a portable electronic device operating according to sensed movements thereof and operating method for the same.

### DESCRIPTION OF RELATED ART

At present, ever smaller and more portable electronic devices, such as digital cameras and mobile phones, are in demand, while at the same time larger screens are desired for displaying menus or pictures on the very same electronic devices.

For a typical electronic device, many buttons, which compete for space with the display screen are used for operating the electronic device.

What is needed, therefore, is an electronic device which can be operated with fewer buttons, to allow more space for a display, and still fulfill the demand for greater miniaturization.

### SUMMARY

In accordance with one present embodiment, a portable electronic device includes a movement sensor and a processor. The movement sensor is configured for detecting different types of movements of the portable electronic device and generating a corresponding signal representing each type of movement. The processor is configured for receiving the signal generated by the movement sensor and generating an operating signal for operating the portable electronic device corresponding to each movement type.

### BRIEF DESCRIPTION OF THE DRAWINGS

Many aspects of the present portable electronic device can be better understood with reference to the following drawings. The components in the drawing are not necessarily drawn to scale, the emphasis instead being placed upon clearly illustrating the principles of the present portable electronic device. Moreover, in the drawings, like reference numerals designate corresponding parts throughout the several views.

FIG. 1 is a schematic view of a portable electronic device according to a present embodiment;

FIG. 2 is a schematic, functional block diagram of the portable electronic device of FIG. 1;

FIG. 3 and FIG. 4 are schematic views of the portable electronic device of FIG. 1 respectively indicating two working states; and

FIG. 5 is a flow chart of an operating method for the portable electronic device of FIG. 1.

### DETAILED DESCRIPTION OF THE EMBODIMENTS

Embodiments will now be described in detail below, with reference to the drawings.

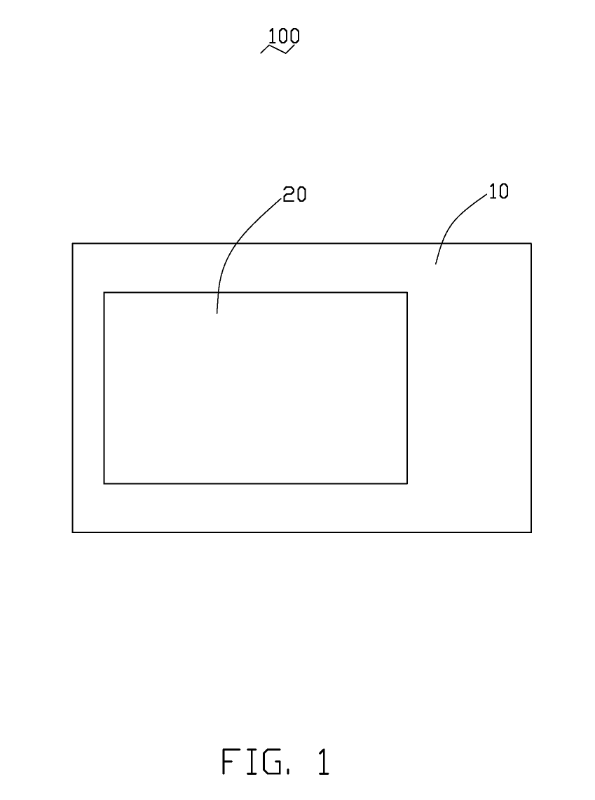

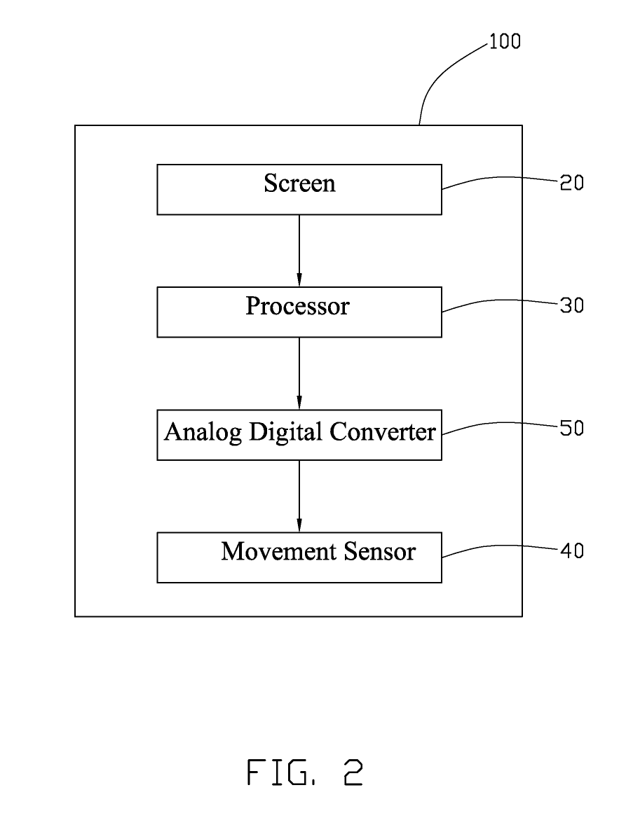

Referring to FIG. 1 and FIG. 2, a portable electronic device 100, according to an embodiment, is shown. The portable electronic device 100 includes a housing 10, a screen 20, a processor 30, and a movement sensor 40.

The portable electronic device 100 can be a digital camera, a video camera or a mobile phone and etc. The screen 20 is disposed on an outer surface of the housing 10 for displaying menus, pictures and so on.

The movement sensor 40 can be secured on an outer surface of the housing 10 or secured in the housing 10. Preferably, the movement sensor 40 is secured in the housing 10, so that, the space of the outer surface of the housing 10 is saved for disposing the screen 20 and other structures thereon. The movement sensor 40 is configured for detecting types of movements of the portable electronic device 100 and generating a corresponding signal representing each type of movement. Characteristics of each type of movement include acceleration, speed, direction of motion and so on. The type of the movement can be distinguished according to predetermined parameters for above-mentioned characteristics. The movement sensor can be an accelerometer, a speedometer, a gyroscope, a gravity sensor or combination of these. In the present embodiment, the portable electronic device 100 further includes an analog digital converter 50. The analog digital converter 50 is electronically coupled between the movement sensor 40 and the processor 30. Because the signal generated by the movement sensor 40 is usually an analog signal, the analog digital converter 50 is beneficially used for converting the analog signal to a digital signal, which may then be easily processed by the processor 30.

The processor 30 is electrically connected with the movement sensor 40 and can receive the signal generated by the movement sensor 40. The processor 30 can generate an operating signal for operating the portable electronic device 100 corresponding to each type of movement of the portable electronic device 100 detected. The relationship between types of movements and types of operating signals is preset in the processor 30.

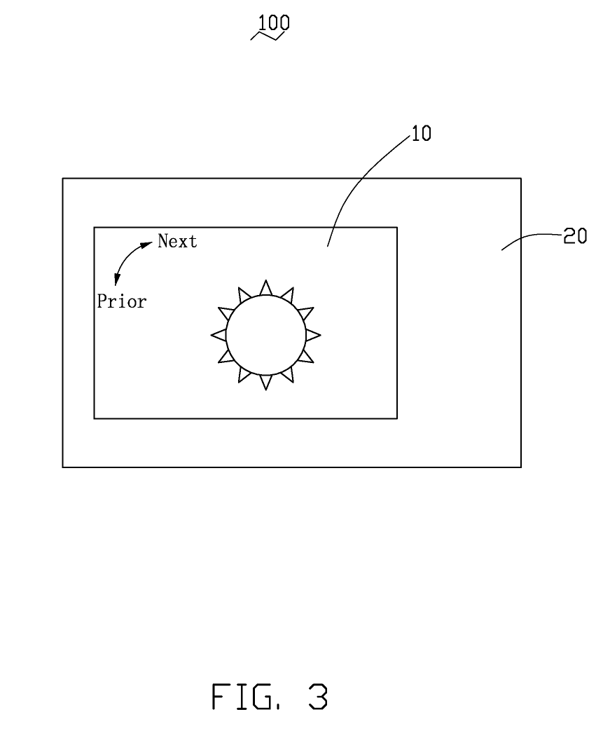

In the present embodiment, the movement sensor 40 is an accelerometer. Preferably, the accelerometer is a three axes accelerometer. The accelerations measured by the accelerometer can be divided into many types according to acceleration level and direction of the acceleration. The processor 30 generates an operating signal for operating the portable electronic device 100 corresponding to each type of acceleration measured by the accelerometer. Referring to FIG. 3, in a picture view mode of the portable electronic device 100 according to the present embodiment, when the portable electronic device 100 has a clockwise acceleration, the processor 30 will generate an operating signal for the portable electronic device 100 to display a next picture. And when the portable electronic device 100 has an anti-clockwise acceleration, the processor 30 will generate an operating signal for the portable electronic device 100 to display a previous picture. So, the portable electronic device 100 can display a next picture or a previous picture according to rotation of the portable electronic device 100, thereby reducing the number of buttons needed for operating the portable electronic device 100.

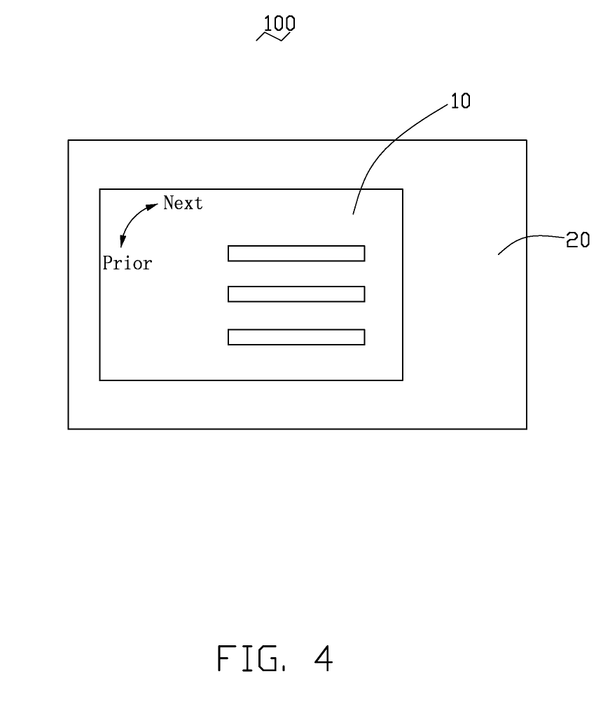

To aid a user operating the portable electronic device 100, the screen 20 of the portable electronic device 100 can display words or icons representing the operating signal corresponding to each type of movement of portable electronic device 100. In the present embodiment, a same type of the movement can activate different operating signals depending on current working mode of the portable electronic device 100. For example, referring to FIG. 4, in another working mode of the portable electronic device 100, rotating the portable electronic device 100 clockwise and anti-clockwise can select a next option and a previous option.

In order to prevent the processor 30 from generating an operating signal according to a random minor movement of the portable electronic device 100, a preset value for a minimum magnitude of movement can be programmed into the processor 30.

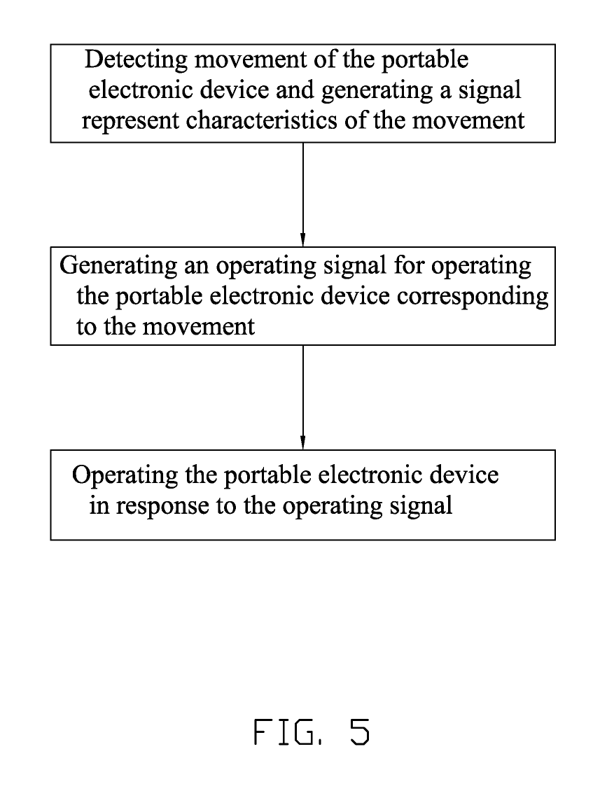

Referring to FIG. 5, an operating method for the portable electronic device 100 is also provided. The method includes the steps of: detecting movement of the portable electronic device and generating a signal representing one or more characteristics of the movement; generating an operating signal for operating the portable electronic device corresponding to the movement; and the portable electronic device performs a function in response to the operating signal.

In the present embodiment, the movement sensor 40 is used for detecting movements of the portable electronic device and generating a corresponding signal representing one or more characteristics of each type of movement. Because the signal generated by the movement sensor 40 is usually an analog signal, the method can also include a step of converting the signal generated by the movement sensor from analog to digital, before generating an operating signal for operating the portable electronic device 100. The method can also include a step of identifying the current working mode of the portable electronic device 100 and then generating the operating signal corresponding to the movement for activating a function specific to that working mode. In order to avoid a false signal being initiated by minor movement of the portable electronic device 100a step of comparing the characteristic of the movement to a preset value, when the characteristic of the movement is smaller than a preset value, no operating signal will be generated.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A portable electronic device comprising:
a movement sensor configured for detecting types of movements of the portable electronic device and generating a signal representing characteristics of each type of movement; and
a processor configured for receiving the signal generated by the movement sensor and generating an operating signal for operating the portable electronic device to perform a function corresponding to each type of movement.

2. The portable electronic device as claimed in claim 1, further including a housing and the movement sensor is secured in the housing.

3. The portable electronic device as claimed in claim 1, wherein the movement sensor is selected from a group consisting of an accelerometer, a speedometer, a gyroscope, and a gravity sensor.

4. The portable electronic device as claimed in claim 1, wherein the characteristics of the types of movements are selected from a group consisting of acceleration, speed, and direction of motion.

5. The portable electronic device as claimed in claim 1, further including an analog digital converter, the analog digital converter being electronically coupled between the movement sensor and the processor and configured for converting the signal generated by the movement sensor to a digital signal.

6. The portable electronic device as claimed in claim 1, wherein there is a one to one relationship between the types of movements and the types of operating signals.

7. The portable electronic device as claimed in claim 1, wherein a plurality of types of movements corresponds to a single type of operating signal.

8. The portable electronic device as claimed in claim 1, wherein the portable electronic device has a plurality of working modes and one type of movement activates different operating signals in different working modes of the portable electronic device.

9. The portable electronic device as claimed in claim 1, further including a screen and the screen displays words or icons representing the operating signal corresponding to each type of movement of the portable electronic device.

10. The portable electronic device as claimed in claim 1, wherein if a characteristic of a movement is smaller in magnitude than a preset value in the processor, no operating signal according to the movement is generated.

11. An operating method for a portable electronic device, comprising the steps of:
detecting movement of the portable electronic device and generating a signal representing characteristics of the movement;
generating an operating signal for operating the portable electronic device corresponding to the movement; and
operating the portable electronic device in response to the operating signal.

12. The method as claimed in claim 11, further including a step of converting the signal representing characteristics of the movement to a digital signal before generating an operating signal for operating the portable electronic device.

13. The method as claimed in claim 11, further including a step of identifying the current working mode of the portable electronic device t before generating the operating signal corresponding to the movement.

14. The method as claimed in claim 1, wherein the characteristic of the movement is selected from a group consisting of acceleration, speed, and direction of movement.

15. The method as claimed in claim 11, wherein the relationship between types of the movements and types of operating signals is each type of the movement corresponding to each type of operating signal.

16. The method as claimed in claim 11, wherein the relationship between types of the movements and types of operating signals is a plurality of types of the movements corresponding to a type of operating signal.

17. The method as claimed in claim 11, wherein the method further includes a step of comparing the characteristic of the movement in magnitude with a preset value before generating an operating signal, if the characteristic of the movement is smaller than the preset value, no operating signal is generated.
